(19) United States
(12) Patent Application Publication
(10) Pub. No.: US 2025/0244635 A1
(43) Pub. Date: Jul. 31, 2025

(54) SOLITON GENERATION USING CRYSTALLINE WHISPERING GALLERY MODE RESONATORS

(71) Applicant: BAE SYSTEMS Information and Electronic Systems Integration Inc., Nashua, NH (US)

(72) Inventors: Zakary N. Burkley, Amherst, NH (US); Craig C. Price, Manchester, NH (US); Mackenzie A. Van Camp, Lowell, MA (US); John Jost, Chardonne (CH); Thien An Nguyen, Austin, TX (US); Leif Johansson, Santa Barbara, CA (US)

(21) Appl. No.: 18/426,940

(22) Filed: Jan. 30, 2024

(51) Int. Cl. G02F 1/35; G02B 6/293; G02B 6/42; G02F 1/365; H01S 3/063

(52) U.S. Cl. CPC G02F 1/3513; G02B 6/29341; G02B 6/4201; G02F 1/365; H01S 3/063

(57) ABSTRACT

Photonic coupling mechanisms and techniques are described. In one example, a method includes writing a photonic wirebond to at least one optical waveguide to position the photonic wirebond at a first coupling position relative to a crystalline microresonator, injecting optical power into the at least one optical waveguide, determining a number of generated light modes within the crystalline microresonator, and performing a peak search to locate at least one soliton step corresponding to at least one of the generated light modes within the crystalline microresonator.

### STATEMENT OF GOVERNMENT INTEREST

This invention was made with United States Government assistance under Grant No. HR001122C0039 awarded by the Defense Advanced Research Projects Agency. The United States Government has certain rights in this invention.

### FIELD OF DISCLOSURE

The present disclosure relates to photonic systems and, more particularly, to processes for generating solitons using microresonators.

### BACKGROUND

High-Q optical microresonators provide a number of useful properties for a wide variety of photonic applications, including non-linear photonics. In particular, bulk crystalline microresonators have several attractive properties and offer advantages over photonic integrated circuit-based microresonators in terms of optical power specifications and ease of manufacture. However, optical coupling to crystalline microresonators remains a significant challenge. For instance, such optical coupling can be accomplished with free-space optical couplers, such as prisms, tapered optical fibers, or angle-cleaved optical fibers, but such optical elements are bulky, fragile, and/or difficult to manufacture. Accordingly, non-trivial issues remain with respect to using crystalline microresonators in photonic systems.

### SUMMARY

Aspects and embodiments are directed to techniques for aligning coupling elements to crystalline optical whispering gallery mode microresonators for soliton generation.

According to one embodiment, a method comprises writing a photonic wirebond to at least one optical waveguide to position the photonic wirebond at a first coupling position relative to a crystalline microresonator, injecting optical power into the at least one optical waveguide, determining a number of generated light modes within the crystalline microresonator, and performing a peak search to locate at least one soliton step corresponding to a generated light mode within the crystalline microresonator.

According to another embodiment, a system comprises a photonic integrated circuit having at least one optical waveguide formed thereon, a crystalline microresonator spaced apart from the photonic integrated circuit, a laser system coupled to the at least one optical waveguide, a photonic wirebond generator, and a controller. The controller may be configured to control the photonic wirebond generator to write a photonic wirebond to at least one optical waveguide to position the photonic wirebond at a first coupling position relative to a crystalline microresonator, control the laser system to inject optical power into the at least one optical waveguide, determine a number of generated light modes within the crystalline microresonator, and perform a peak search to locate at least one soliton step corresponding to a generated light mode within the crystalline microresonator.

Another embodiment is directed to a computer program product comprising one or more non-transitory machine-readable mediums having instructions encoded thereon that when executed by at least one processor cause a method for generating solitons in a microresonator to be carried out. The method may comprise writing a photonic wirebond to at least one optical waveguide to position the photonic wirebond at a first coupling position relative to the microresonator, injecting optical power into the at least one optical waveguide, determining a number of generated light modes within the microresonator, and performing a peak search to locate at least one soliton step corresponding to a generated light mode within the microresonator.

Still other aspects, embodiments, and advantages of these example aspects and embodiments are described in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

In the figures:

FIG. 1 is a diagram illustrating a plan view (top-down) of an example of a loopback photonic wirebond according to aspects of the present disclosure;

FIG. 2A is a diagram illustrating a perspective view of an example of a photonic wirebond providing a coupling mechanism between a photonic integrated circuit and a crystalline microresonator according to aspects of the present disclosure;

FIG. 2B is a diagram illustrating a side view of an example of a photonic wirebond providing a coupling mechanism between a photonic integrated circuit and a crystalline

FIG. 3 is diagram of one example of a loopback photonic wirebond according to aspects of the present disclosure;

FIG. 4 is a diagram showing a portion of the loopback photonic wirebond of FIG. 3 having an elliptical profile according to aspects of the present disclosure;

FIG. 5 is a diagram illustrating a portion of a fiber array having a plurality of loopback photonic wirebonds attached thereto according to aspects of the present disclosure;

FIG. 6 is a block diagram of a test system for measuring various characteristics of a photonic wirebond according to aspects of the present disclosure;

FIG. 7 is a diagram illustrating a top-down view of an example of a loopback photonic wirebond and a microresonator according to aspects of the present disclosure;

FIG. 8A is a graph illustrating an example of a resonance mode of a coupling device using the photonic wirebond and microresonator of FIG. 2A obtained using the test system of FIG. 6 according to aspects of the present disclosure;

FIG. 8B is a graph illustrating different coupling states as a function of a gap between the photonic wirebond and microresonator of FIG. 2A obtained using the test system of FIG. 6 according to aspects of the present disclosure.

FIG. 9 is a block diagram of another example of a test system for measuring various characteristics of a photonic wirebond according to aspects of the present disclosure;

FIG. 10 is a graph illustrating soliton formation according to aspects of the present disclosure;

FIG. 11 is a diagram showing a cross-sectional view of an example of a crystalline microresonator with various coupling volumes according to aspects of the present disclosure;

FIG. 12A is a diagram illustrating a side view of an example of a photonic wirebond in a first position relative to a microresonator, according to aspects of the present disclosure;

FIG. 12B is a diagram illustrating a side view of an example of the photonic wirebond in a second position relative to the microresonator, according to aspects of the present disclosure;

FIG. 12C is a diagram illustrating a side view of an example of the photonic wirebond in a third position relative to the microresonator, according to aspects of the present disclosure;

FIG. 13A is a graph illustrating a modal profile of light coupled from a microresonator using a photonic wirebond, with the photonic wirebond in a first position relative to the microresonator, according to aspects of the present disclosure;

FIG. 13B is a graph illustrating a modal profile of light coupled from the microresonator using the photonic wirebond, with the photonic wirebond in a second position relative to the microresonator, according to aspects of the present disclosure;

FIG. 13C is a graph illustrating a modal profile of light coupled from the microresonator using the photonic wirebond, with the photonic wirebond in a third position relative to the microresonator, according to aspects of the present disclosure;

FIG. 13D is a graph illustrating a modal profile of light coupled from the microresonator using the photonic wirebond, with the photonic wirebond in a fourth position relative to the microresonator, according to aspects of the present disclosure;

FIG. 13E is a graph illustrating a modal profile of light coupled from the microresonator using the photonic wirebond, with the photonic wirebond in a fifth position relative to the microresonator, according to aspects of the present disclosure;

FIG. 13F is a graph illustrating a modal profile of light coupled from the microresonator using the photonic wirebond, with the photonic wirebond in a sixth position relative to the microresonator, according to aspects of the present disclosure;

FIG. 14 is a graph illustrating an enlarged view of a portion of a modal profile of light coupled from the microresonator using the photonic wirebond, with the photonic wirebond in the second position relative to the microresonator, according to aspects of the present disclosure;

FIG. 15 is a flow diagram illustrating an example of a process for automatically aligning a photonic wirebond to produce solitons in a microresonator, according to aspects of the present disclosure;

FIG. 16 is a block diagram of one example of a system for automated soliton generation using a microresonator and photonic wirebond coupler according to aspects of the present disclosure; and

FIG. 17 is a block diagram of one example of a computing system that can be used to implement one or more components of the system of FIG. 16, according to aspects of the present disclosure.

Although the following detailed description will proceed with reference being made to illustrative embodiments, many alternatives, modifications, and variations thereof will be apparent in light of this disclosure.

### DETAILED DESCRIPTION

Techniques are disclosed herein for coupling to a crystalline optical microresonator using a photonic wirebond to generate solitons and a pure, low-noise microwave signal based on Kerr-microcombs. The techniques can be used, for instance, to allow for heterogeneous integration of a crystalline microresonator with a photonic integrated circuit while avoiding the need for active alignment. Examples provide for manufacturable devices and automated methods for generating solitons in crystalline microresonators.

According to certain examples, a method includes writing a photonic wirebond to at least one optical waveguide to position the photonic wirebond at a first coupling position relative to a crystalline microresonator, injecting optical power into the at least one optical waveguide, and determining a number of generated light modes within the crystalline microresonator. The generated light modes may represent modes having non-linearities that may produce solitons. Accordingly, in some examples, the method includes performing a peak search to locate at least one soliton step corresponding to a generated light mode within the crystalline microresonator. In some examples, the method includes rewriting the photonic wirebond to various positions with respect to the microresonator and determining a position at which a highest number of generated light modes occurs. The photonic wirebond can be aligned at this position, and the peak search performed to locate one or more soliton steps. The method may be automated and performed by a system under control of a programmed controller, for example.

These and other features of photonic wirebond structures and alignment processes for soliton generation are described in more detail below.

### General Overview

High-Q optical microresonators have properties that provide numerous advantages and opportunities in various fields of modern photonics. Their small size and high optical field density provide an opportunity to generate various nonlinear effects at low input optical power and low power consumption within a scalable and compact form factor. There are two types of microresonators that are used in photonics applications, those that are located on (or integrated with) a PIC (referred to as PIC-based microresonators) and those that are separate from the PIC (e.g., bulk crystalline microresonators). Crystalline optical microresonators offer several advantages over PIC-based optical microresonators. For example, crystalline optical microresonators can be mass-manufactured from a variety of materials and can support ultra-high quality factors (e.g., Q≈1 billion) within the ultraviolet to mid-infrared wavelength range. Additionally, magnesium fluoride (MgF2) naturally exhibits anomalous material dispersion in the C-band which enables microcomb generation without the need for the complicated geometries associated with dispersion engineering. A typical soliton repetition rate for MgF2 microresonators is tens of GHz and, due to their ultra-high Q, the nonlinear power threshold is in the milliwatt range. Low repetition rates in the GHz range are compatible with standard microwave electronics and as such can be directly accessed without need for additional frequency down-conversion architectures. PIC-based microcombs on the other hand use power levels at the watt-level for solitons with these repetition rates. In addition, the larger effective mode area (volume) of crystalline microresonators, as compared to their PIC-based equivalents, leads to lower thermorefractive noise (TRN), which can be a limiting factor in laser frequency stabilization. However, despite these advantages over PIC-based microresonators, optical coupling to crystalline optical microresonators is challenging and presents a significant barrier to the use of crystalline optical microresonators in many applications.

In order to use a crystalline optical microresonator for a photonics application, a mechanism is needed to couple light from the PIC into the three-dimensional structure of the optical microresonator that is located off the PIC, and then from the microresonator back into the PIC. As described above, some examples of coupling approaches include tapered optical fibers, prisms, angle-cleaved fibers, and grating-based fiber couplers. These approaches, however, are bulky, fragile, sensitive to vibration, and/or involve the use of free-space optical elements. As a result, they are not well-suited for high-volume production. Another possible approach might be use of a free-hanging silica waveguide on a silicon chip to couple to a crystalline microresonator lying on its side. However, such an approach involves relatively complex design, fabrication and alignment procedures, and high losses. The PIC itself can be used to inject light into a crystalline microresonator. However, this coupling approach, while compact, is not suitable for certain crystalline materials, such as low refractive index MgF2 bulk material (n≈1.37 at 1550 nanometers (nm)), which is a preferred material for some photonic applications. Accordingly, non-trivial issues remain with respect to coupling to crystalline optical microresonators.

In addition, while crystalline optical whispering gallery mode microresonators can be used to create soliton Kerr frequency combs (coherent optical frequency combs), coupling to these microresonators effectively enough to generate solitons is very challenging. Furthermore, the practical implementation of such coupling is an active process that usually requires an expert in the field.

Thus, described herein are techniques for providing a compact, manufacturable, and robust evanescent coupling solution using a photonic wirebond. Using these photonic wirebonds as coupling devices, further techniques disclosed herein provide automated processes for generating solitons in crystalline microresonators that remove the need for active alignment. An example of a process involves characterizing the coupling dependence on the photonic wirebond position in cartesian coordinates (e.g., x, y, z) and the density of generated soliton states based on the wirebond position. Thus, coupling dependence information can be produced, the coupling dependence information specifying coupling parameters (e.g., the amount of coupling, whether the coupling state is under-coupled, over-coupled, or critically-coupled, and/or the extinction ratio at one or more resonance frequencies) as a function of the spatial position of the photonic wirebond in three dimensions relative to a selected point on the coupling surface of the microresonator. From this coupling dependence information, certain examples provide an automated method to write photonic wirebonds to microresonators for maximum soliton generation.

As described further below, certain embodiments provide a photonic wirebond loopback evanescent coupler and a tuning methodology that can be used to automatically control coupling with a discrete crystalline microresonator to produce solitons. Examples of the photonic wirebond have a particular geometry that allows the photonic wirebond to be used to couple light from a laser or other optical source between an optical waveguide (e.g., an optical fiber) on a PIC and an off-PIC crystalline optical microresonator with good coupling efficiency. According to certain examples, the photonic wirebond is formed with a loop structure having a geometry (e.g., profile, length, loop dimensions) that provides a robust coupling mechanism and allows for sufficiently effective evanescent coupling with the off-PIC crystalline microresonator to reliably and repeatably generate solitons, as described in more detail below. Examples of the loopback photonic wirebond can be manufactured using techniques that are compatible with high-volume production and automated processes for soliton generation.

For example, according to certain embodiments, a method includes writing a photonic wirebond (e.g., using a robotic apparatus) to at least one optical waveguide to position the photonic wirebond at a first coupling position relative to a crystalline microresonator, and injecting optical power into the at least one optical waveguide using a laser system, for example. The method may include determining a number of generated light modes within the crystalline microresonator and storing this information, together with the corresponding spatial position of the photonic wirebond, in a computer readable storage medium, for example. These processes may be repeated for several different spatial positions of the photonic wirebond. Examples of the method may further include performing a peak search to locate at least one soliton step corresponding to at least one of the generated light modes within the crystalline microresonator.

In some examples, the photonic wirebond is formed as a loopback photonic wirebond comprising a first tapered end region having a circular profile and tapering in diameter from a first diameter at a first end face to a second diameter at a first point a first length away from the first end face, a second tapered end region having the circular profile and tapering in diameter from the first diameter at a second end face to the second diameter at a second point the first length away from the second end face, and a loop portion extending from the first point to the second point. The loop portion may have an elliptical profile with the second diameter in a first dimension and a third diameter in a second dimension perpendicular to the first dimension, the third diameter being larger than the second diameter. The loop portion can be configured to position the second tapered end region parallel to the first tapered end region. The first and second end faces can be written to connection facets of the at least one optical waveguide so as to couple the photonic wirebond to the at least one optical waveguide. The optical waveguide may be formed on a substrate. The substrate and the photonic wirebond can be positioned with respect to a microresonator such that the loop portion of the photonic wirebond is proximate or in contact with the microresonator to thereby couple light into and out of the microresonator via evanescent coupling. As used herein, a waveguide that is said to be on a substrate is intended to include cases where the waveguide is on a surface of the substrate, or within the substrate, or otherwise a part of, or formed within or on, the substrate.

### Example Device Architecture

According to certain examples, a photonic wirebond can be used as an evanescent coupler to couple light (e.g., from a laser or other optical source) between an optical waveguide on a substrate, such as a PIC, and an off-PIC crystalline optical microresonator. Evanescent coupling is a process by which electromagnetic waves are transmitted from one medium to another via the evanescent, exponentially decaying electromagnetic field. Coupling may be usually accomplished by placing two or more electromagnetic elements, such as optical waveguides, close together so that the evanescent field generated by one element does not decay much before it reaches the other element. For example, evanescent coupling can be achieved though Frustrated Total Internal Reflection (FTIR) in which an evanescent field very close to the surface of a dense medium at which a wave normally undergoes total internal reflection overlaps another dense medium that is close by. This overlap of the evanescent field disrupts the totality of the reflection, diverting some power into the second medium. As described in more detail below, photonic wirebonds can be formed with various different loop structures to provide an evanescent coupling mechanism to couple light (optical power) between an optical waveguide and a crystalline microresonator.

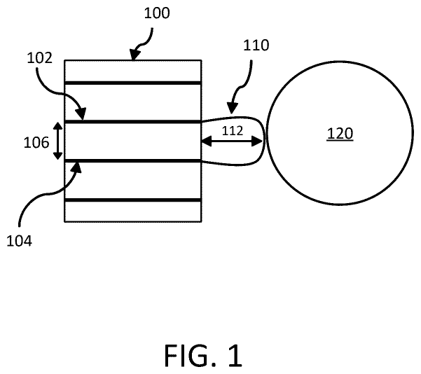

FIG. 1 is a diagram illustrating a plan (top-down) view of photonic system including a photonic wirebond coupler according to certain examples. In this example, a photonic integrated circuit (PIC) 100 includes a first optical waveguide 102 and a second optical waveguide 104. A photonic wirebond 110 is coupled to the first and second optical waveguides 102, 104 and configured to form a loop extending away from the PIC 100, as shown. The first and second optical waveguides 102, 104 are spaced apart from one another by a center-to-center spacing (“pitch”) 106. In the illustrated example, the first and second optical waveguides 102, 104 extend parallel to one another with uniform pitch. However, in other examples, the arrangement of the first and second optical waveguides 102, 104 may be different, and the pitch 106, as used herein, may refer to the center-to-center spacing of the first and second optical waveguides 102, 104 at connection points at which the first and second optical waveguides 102, 104 are coupled to the photonic wirebond 110. In some examples, the first and second optical waveguides 102, 104 are optical fibers.

The photonic wirebond 110 has an extension length 112 measured from ends of the photonic wirebond 110 attached to the first and second optical waveguides 102, 104 and a tip region, or furthest extension of the loop away from the ends of the photonic wirebond 110. In the illustrated example, the photonic wirebond 110 extends away from the PIC 100, and towards a crystalline microresonator 120, in a plane of the first and second optical waveguides 102, 104. The crystalline microresonator 120 may be positioned with respect to the PIC 100, and/or the extension length of the photonic wirebond 110 may be selected, such that the photonic wirebond 110 contacts the microresonator 120 or is positioned with a certain gap between the tip region of the loop and the microresonator 120, as described further below.

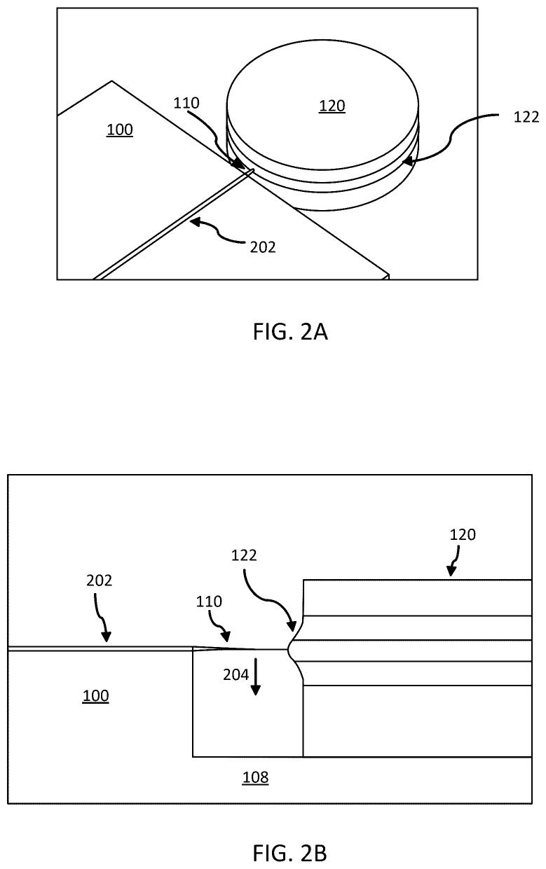

FIGS. 2A and 2B are diagrams illustrating photonic systems having configurations similar to that shown in FIG. 1. Referring to FIG. 2A, there is illustrated a perspective view of an example of a photonic system including the PIC 100 and the microresonator 120. An optical waveguide 202 is formed on the PIC 100. The optical waveguide 202 may include the pair of optical waveguides 102, 104, for example. In some examples, the optical waveguide 202 includes a pair of optical fibers, as described above. In other examples, the optical waveguide 202 may be formed using other optical waveguide technology. The photonic wirebond 110 is coupled to the optical waveguide 202, as shown.

In some examples, the crystalline microresonator 120 includes a protrusion 122. In some examples, the microresonator 120 is circular in cross-section (e.g., generally having a cylindrical shape, as shown in FIGS. 1 and 2A), and the protrusion 122 is an annular protrusion that extends around a circumference of the microresonator 120. Accordingly, the microresonator 120 may have a larger diameter in the region of the protrusion 122 than the diameter of the remainder of the body of the microresonator 120. In some examples, the diameter of the body of the microresonator 120 is in a range of about 1 mm-5 mm. In one example, diameter of the microresonator 120 at a mid-point or “equator” of the protrusion 122 may be extended by approximately 100-200 micrometers (μm) relative to the diameter of the body of the microresonator 120. The microresonator 120 may be made of any of a variety of bulk crystalline materials suitable for photonics applications, including but not limited to, magnesium fluoride (MgF2), for example.

FIG. 2B is a side view of an example of the photonic system of FIG. 2A. In this example, the photonic wirebond 110 extends from the PIC 100 across a silicon trench 108 to contact (or approach) the protrusion 122 of the microresonator 120. In some examples and orientations of the photonic system, the downward force of gravity on the photonic wirebond 110 as it extends across the trench 108 (indicated by arrow 204) can cause the photonic wirebond to droop downwards, rather than remain in a perfectly level plane. Accordingly, the alignment of the photonic wirebond 110 with the microresonator 120 and/or the extension length of the photonic wirebond 110 may be tailored to account for some droop. For example, the photonic wirebond 110 can be initially aligned slightly above the midpoint (or “equator”) of the microresonator 120, such that as gravity-induced droop causes the at least the end of the photonic wirebond 110 to bend downwards, the tip region of the loop contacts and rests against the protrusion 122. This configuration may naturally and advantageously provide some resilience or robustness of the coupling to vibration or other mechanical perturbances.

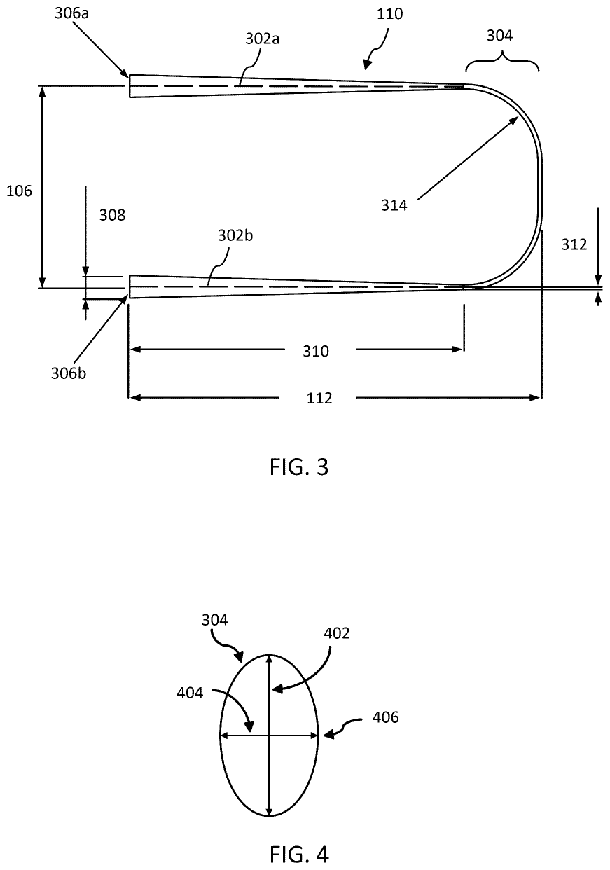

Referring now to FIG. 3, there is illustrated a diagram showing a structure and dimensions of the loopback photonic wirebond 110 according to some examples. In this example, the photonic wirebond 110 includes two end regions 302a, 302b, and a U-shaped loopback portion 304 extending between the two end regions 302a, 302b. The end regions 302a, 302b have fixed face anchor points 306a, 306b, respectively, that provide a waveguide interface and can be used to anchor the photonic wirebond 110 to optical waveguides, such as the optical waveguides/fibers 102, 104 on the PIC 100, for example. In some examples, the photonic wirebond 110 is a freeform optical waveguide, and the end regions 302a, 302b include tapered portions of the optical waveguide. The tapered portions may have a circular profile (or cross-section). In one example, a first diameter 308 of the tapered portions at the fixed face anchor points 306a, 306b, may be approximately 15 μm (e.g., 15 μm±<10%). The end regions 302a, 302b, may taper in diameter over the length 310 of the individual end regions to a second diameter 312 at a junction with the loopback portion 304. In one example, the second diameter 312 may be approximately 2 μm (e.g., 2 μm±<10%). According to certain examples in which the photonic wirebond 110 is to be used for coupling with a crystalline microresonator 120 made of MgF2, these particular values for the diameters 308, 312 are selected because the effective index (neff) for the fundamental TE mode can be engineered through the photonic wirebond geometry to match that of MgF2. In other examples or for other applications, different diameter values may be selected. In some examples, the length 310 of the end regions 302a, 302b may be at least 40 μm to ensure efficient coupling. For example, the length 310 of the end regions 302a, 302b may be in a range of about 40 μm to 250 μm, or 100 μm to 250 μm, or in some examples, approximately 210 μm (e.g., 210 μm±<10%).

In some examples, the loopback portion 304 includes an elliptical coupler, such that at least a portion of the loopback portion 304 has an elliptical cross-section, as shown in FIG. 4, for example. The elliptical optical waveguide forming the loopback portion 304 may have a major diameter 402 that is approximately double the dimension of the minor diameter 404. In some examples, the minor diameter 404 is selected to substantially match the second diameter 312 (e.g., to be the same as the second diameter within a small or otherwise acceptable margin of error, such as <1%, for example). In one example, the minor diameter 404 is approximately 2 μm (e.g., 2 μm±<10%) and the major diameter 402 is approximately 4 μm (e.g., 4 μm±<10%). The elliptical optical waveguide of the loopback portion 304 may be oriented such that the major diameter is substantially parallel to the surface of the microresonator 120, such that the loopback portion 304 has a contact region 406 that contacts the microresonator 120. The use of an elliptical coupler may be advantageous in that it allows for tuning in two dimensions which may allow individual tuning of different characteristics or parameters of the coupler. For example, the coupling efficiency can be tuned by tuning the minor diameter 404 to keep the optical waveguide of the loopback portion 304 relatively narrow in one dimension, which allows more light to be coupled into the microresonator 120 via a greater extent of the evanescent field (higher coupling efficiency). Tuning the major diameter 402 allows the optical waveguide to made longer in the other dimension, thereby increasing the surface area of the optical waveguide, which allows the photonic wirebond 110 to support higher optical power.

Referring again to FIG. 3, the end regions 302a, 302b and the loopback portion 304 may be regions of a single optical waveguide that is constructed with different geometric properties (e.g., diameter, taper, profile) in the different regions. The loopback portion 304 has a radius of curvature 314. In some examples, the radius of curvature 314 is in a range of about 40 μm to 55 μm, or 45 μm to 50 μm, or in some examples, approximately 48.5 μm (e.g., 48.5 μm±<10%). As described above, the pitch 106 is the center-to-center spacing between the optical waveguides to which the photonic wirebond 110 is to be coupled, and therefore corresponds to the center-to-center spacing between the end regions 302a, 302b, as shown in FIG. 3. In some examples, the pitch 106 is in a range of about 100 μm to 250 μm, or in some examples, approximately 127 μm (e.g., 127 μm±<10%). In some examples, the extension length 112 of the photonic wirebond 110 is in a range of about 100 μm to 300 μm. Thus, the various aspects of the geometry of the loopback photonic wirebond 110 may be selected and tuned so as to provide a coupling mechanism that is capable of handling high optical power, while also being robust and repeatably manufacturable with good reliability. It will be appreciated, however, that photonic wirebonds as described herein may have different dimensions depending on a variety of factors, including the application for which the coupling mechanism is being designed, and the dimensions provided herein are illustrative examples only and not intended to be limiting.

According to certain examples, the photonic wirebond 110 can be manufactured using additive three-dimensional (3D) printing techniques. The use of 3D printing allows the photonic wirebonds 110 to be manufactured with precisely controllable, yet widely variable, dimensions and geometry that can be tailored to specific applications. In other examples, the photonic wirebond 110 can be formed using laser-based deposition and/or etching techniques. Other manufacturing techniques may also be used. In some examples, the photonic wirebond 110 can be made of a photoresist material; for example, a negative-tone photoresist material, such as SU-8, for example. The selection of SU-8 may be advantageous in some applications because its refractive index is a good match to the refractive index of MgF2, which may be often used for the microresonator 120. These photonic wirebonds may be written onto the facets of fiber arrays or PICs using a two-photon polymerization process.

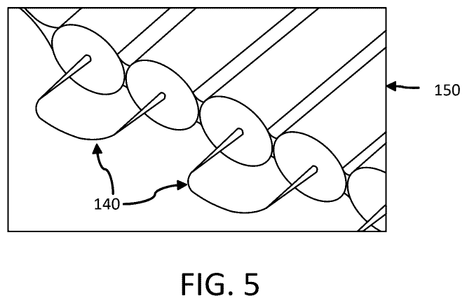

FIG. 5 illustrates an example of loopback photonic wirebonds 110, such as described above with reference to FIGS. 3 and 4, written to a fiber array 500. For example, the photonic wirebonds may be formed using one of the techniques mentioned above (e.g., 3D printing and/or laser etching) and attached to facets of the optical fibers using a two-photon polymerization process or other attachment technique. In this example, the fiber array 500 is a V-groove multi-channel array comprising a plurality of optical fibers. As described above, the fixed face anchor points 306a, 306b (FIG. 3) provide interfaces (or input/output ports) between the photonic wirebonds 110 and the respective optical fibers of the fiber array 500.

As described above, the photonic wirebond 110 operates to couple light from the optical waveguides 102 and/or 104 into the microresonator 120, and from the microresonator 120 back into the optical waveguides 102 and/or 104, via evanescent coupling. Coupling to the microresonator 120 involves refractive index matching between the injected and circulating modes (k-vector matching), and benefits from a large evanescent field extent so as to facilitate light-material interaction. Both of these properties exhibit sensitivity to the geometry of the photonic wirebond 110. Accordingly, the photonic wirebond can be constructed according to examples described with reference to FIGS. 3 and 4 to achieve reliable evanescent coupling with the microresonator 120. Furthermore, the loopback structure of the photonic wirebond 110 supports input/output ports written to coupling facets of the optical waveguides 102, 104, as described above, with relatively low loss and high optical power. In some examples, the total losses from photonic wirebond to fiber array facet junctions (e.g., as depicted in FIG. 5) do not exceed 0.85 dB/facet (at a light wavelength of 1550 nm) and support power handling of more than 400 mW.

Testing of the variation in output power from photonic wirebonds 110 having the construction shown in FIG. 3 over varying ambient temperatures ranging from −40° C. to +85° C. and subject to various mechanical stresses revealed an impressively low 0.3 dB peak-to-peak variation, indicating that the loopback photonic wirebonds 110 can reliably support high optical powers over vastly different operating environments. Thus, examples of the photonic wirebond 110 may provide a robust coupling mechanism for crystalline microresonators suitable for a wide range of photonic applications.

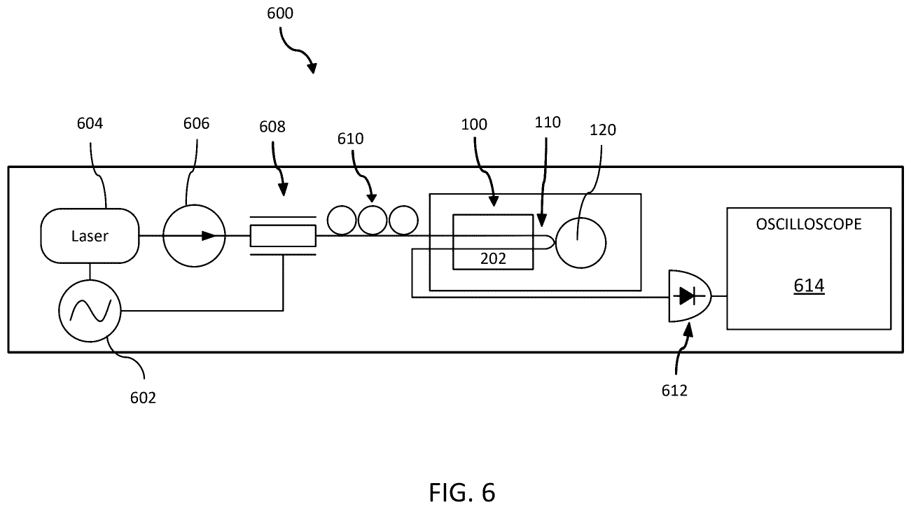

FIG. 6 is a block diagram of one example of a test system that can be used to test various performance characteristics and parameters, such as coupling ideality and Q-factor, of the photonic wirebond 110 in a photonics system having the arrangement shown in FIG. 2A. The test system 600 includes an arbitrary waveform generator 602, a laser 604, an isolator 606, an electro-optical modulator 608, a polarization controller 610, a measurement photodetector 612, and an oscilloscope 614. The laser 604 generates light to be coupled into and out of the microresonator 120 via the photonic wirebond 110 and the optical waveguide 202 on the PIC 100. The measurement photodetector 612 is configured to sample the optical signal returned from the microresonator 120 into the optical waveguide 202 and to provide a corresponding electrical signal to the oscilloscope 614 that produces test results based on the electrical signal. To characterize the linear operating regime at low input optical power (<10 mW), input light from the laser 604 is frequency-modulated by a 10 Hz triangular waveform to reveal a resonance mode spectrum. The electro-optic modulator 608 can be used to provide a time-frequency calibration on the oscilloscope 614 to allow for evaluation of the full-width half maxima (FWHM) of selected resonances and extraction of the associated quality factors.

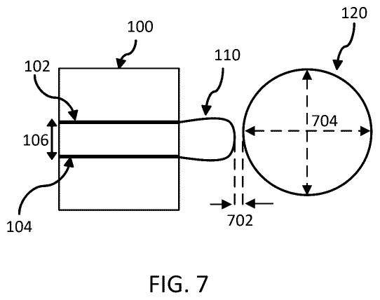

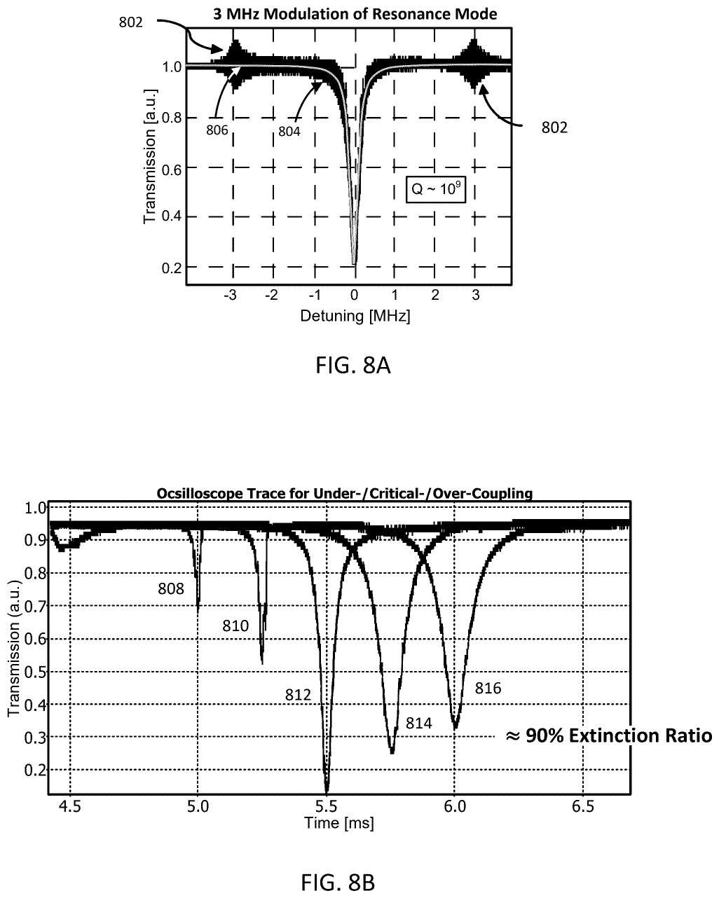

Referring to FIG. 7, there is illustrated a top-down view of an example of the photonic system of FIG. 1, illustrating certain dimensions. To test the coupling performance of the photonic wirebond 110 as a function of the distance 702 between the end of the photonic wirebond 110 and the microresonator 120 in the plane of the photonic wirebond 110, the photonic wirebond 110 can be aligned with the equator 704 of the protrusion 122 of the microresonator 120 (as shown in FIG. 7). The gap 702 between the protrusion 122 and the tip region of the loop of the photonic wirebond 110 can be varied using a piezoelectric stage, for example, to provide under-coupled, critically coupled, and over-coupled states. In each configuration, the linewidth of a particular resonance can be measured using the oscilloscope 614 and the test system 600 shown in FIG. 6. For the following test results illustrated in FIGS. 8A and 8B, a MgF2 microresonator 120 having a diameter of approximately 5 mm, corresponding to a nominal free spectral range of about 14.2 GHz, was used in the test system 600.

FIG. 8A presents a linewidth measurement of a resonance mode. Using 3 MHz calibration sidebands 802 from the electro-optical modulator 608 and normalizing the voltage at the output of the photodetector 612, the measured transmitted light 804 can be fit with a Lorentzian 806. The FWHM of this Lorentzian 708 corresponds to the total microresonator linewidth. In the example of FIG. 8A, the extracted linewidth is 240 kHz, corresponding to a loaded Q-factor of about 1 billion at 1550 nm.

FIG. 8B illustrates the evolution of resonance linewidth as a function of the in-plane gap 702 between the microresonator 120 and the photonic wirebond 110 for a single resonance. The transmission is shown in arbitrary units. Trace 808 corresponds to a gap width of 900 nm, trace 810 corresponds to a gap width of 600 nm, trace 812 corresponds to a gap width of 150 nm, trace 814 corresponds to a gap width of 100 nm, and trace 816 corresponds to contact, or a gap width of 0 nm. In FIG. 8B, all traces 808-816 correspond to the same resonance and have been offset in time to better visualize the transition from under-coupled (traces 808 and 810), to critically coupled (trace 812), to over-coupled (traces 814 and 816) states. Furthermore, the total displacement between under-coupled to over-coupled states is less than 1.5 μm. The measured extinction ratio in the critically coupled state is approximately 85-90% in this example.

According to certain embodiments, the loopback configuration of the photonic wirebond 110 may provide a compact and robust coupling mechanism that also facilitates automating processes for soliton generation using the crystalline microresonator 120. As described above, MgF2 has a cubic nonlinearity and anomalous group velocity dispersion, which allows for the generation of soliton frequency combs in a microresonator made of MgF2. However, coupling to microresonator may need to be precisely controlled in order for soliton generation to occur at particular resonances. While evanescent coupling may be achieved over a range of different positions of the photonic wirebond 110 with respect to the microresonator 120, as shown in FIG. 8B, for example, not all of positions may produce coupling sufficient to generate solitons. Accordingly, certain aspects and examples provide a methodology for obtaining the precise coupling conditions to produce solitons, and techniques for automating the process and avoid the need for expert intervention and/or active, manual alignment steps.

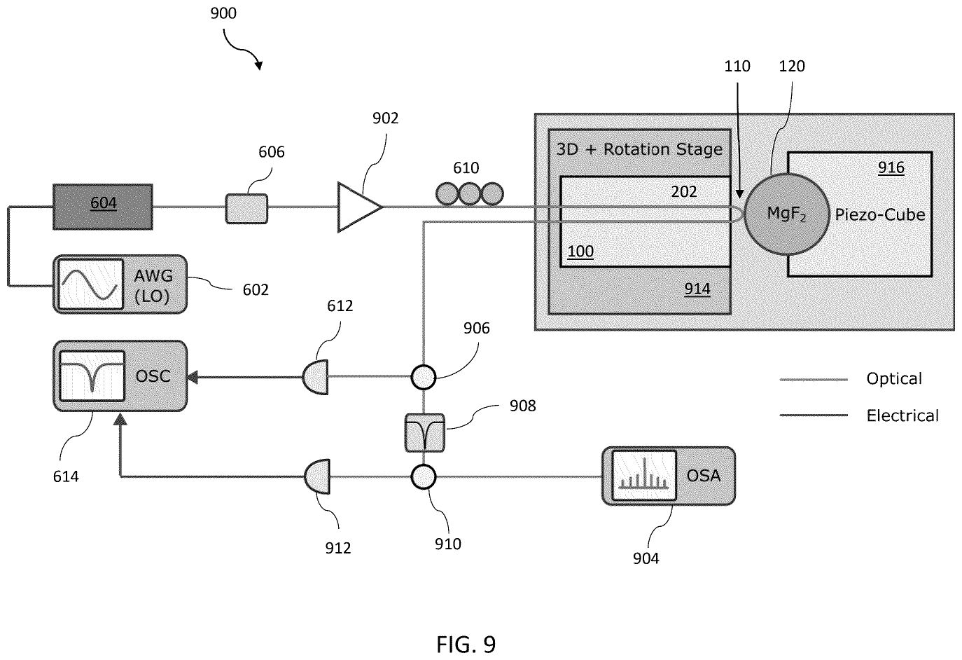

FIG. 9 is a block diagram illustrating an example of a system 900 that can be used to generate solitons in the microresonator 120, via coupling using the photonic wirebond 110, and to produce test results demonstrating soliton generation (or lack thereof) under different conditions. The system 900 is similar to the system 600 of FIG. 6 and further includes components to produce and measure non-linear effects associated with soliton generation. As shown, an erbium doped fiber amplifier (EDFA) 902 is added in the signal path between the laser 604 and the photonic wirebond 110 to augment the amount of optical power coupled to the microresonator 120. In addition to the oscilloscope 614 used for monitoring resonances, an optical spectrum analyzer (OSA) 904 is added to allow observation of the full frequency comb in the single soliton state. Accordingly, the system 900 includes a 50/50 splitter 906 to split the return signal path into two paths, each carrying a portion of the return optical signal, to allow for the additional measurements. A first portion of the return optical signal is sampled by the measurement photodetector 612 to provide a corresponding first electrical signal to the oscilloscope 614 that produces test results based on the electrical signal, as described above. A second portion of the return optical signal is filtered by a notch filter 908 and mixed with a signal from the OSA 904 in a mixer 910. The resulting signal is sampled by a second measurement photodetector 912 to produce a second electrical signal that is passed to the oscilloscope 614, as shown. In some examples, the notch filter 908 is a tunable fiber Bragg grating notch filter.

In some examples, the PIC 100 may be mounted on a movable stage 914 that allows the PIC (and the attached photonic wirebond 110) to be moved up and down and towards and away from the microresonator 120, and also to be rotated. This allows for different positioning of the photonic wirebond 110 with respect to the microresonator 120 to measure how such positioning affects the coupling with the microresonator 120 and the formation of solitons. In some examples, the microresonator 120 is coupled to a piezoelectric stage 916 to allow for movement of the microresonator 120 relative to the PIC 100 and/or for introducing vibration to test robustness of the coupling with the photonic wirebond 110, as described above. For example, the movable stage 914 and/or the piezoelectric stage 916 can be used to vary the distance 702 (FIG. 7) between the tip of the photonic wirebond 110 and the protrusion 122 of the microresonator 120 in the plane of the photonic wirebond 110, as described above, to achieve a desired coupling state (e.g., critically coupled, over-coupled) and extinction ratio. The movable stage 914 may further be used to move the PIC 100, and therefore the photonic wirebond 110, in the vertical dimension (e.g., perpendicular to the plane of the photonic wirebond 110) to determine how variations in this dimension affect the coupling and non-linear effects in the microresonator, as described further below.

As described above, the laser 604 generates light that can be coupled into the microresonator 120 via the photonic wirebond 110. In particular, the laser 604 can be scanned or tuned such that the light beam produced is on resonance with the microresonator 120, meaning that the wavelength of the light beam from the laser 604 is an integer multiple of the length of the microresonator 120. As described above, for the measurement results disclosed herein, the microresonator 120 had a diameter of 4.92 mm, corresponding to a free spectral range (FSR) of 14.2 GHz.

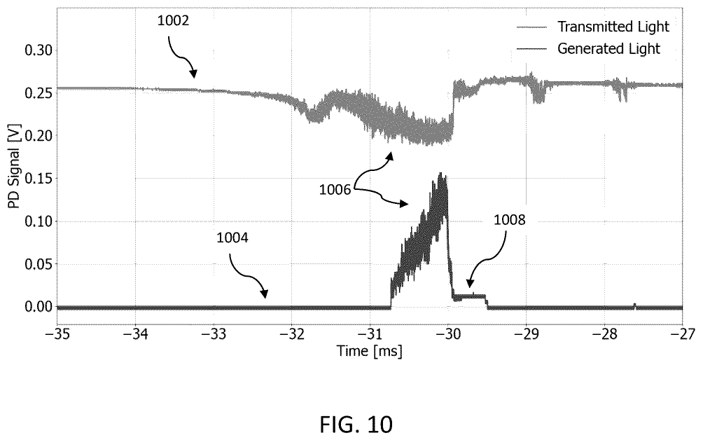

Referring to FIG. 10 there is illustrated a graph showing an example of transmitted light (trace 1002) and light generated in the microresonator 120 (trace 1004), as measured at the oscilloscope 614. The transmitted light corresponds to light generated by the laser 604 and returned from the microresonator 120 via the photonic wirebond 110 and the return optical path, and the generated light corresponds to additional light that is produced within the microresonator 120 and coupled into the return path via the photonic wirebond 110. As shown in FIG. 10, in the resonance condition, light can build up within the microresonator 120, as indicated at 1006. As the coupled optical power increases, non-linear effects can start to be observed. These non-linear effects can produce Kerr frequency combs. When the peak optical power circulating in the microresonator 120 crosses a certain threshold, soliton fission occurs and a soliton step 1008 is produced. The soliton step 1008 corresponds to a very “quiet” frequency comb where the RF phase noise is minimized.

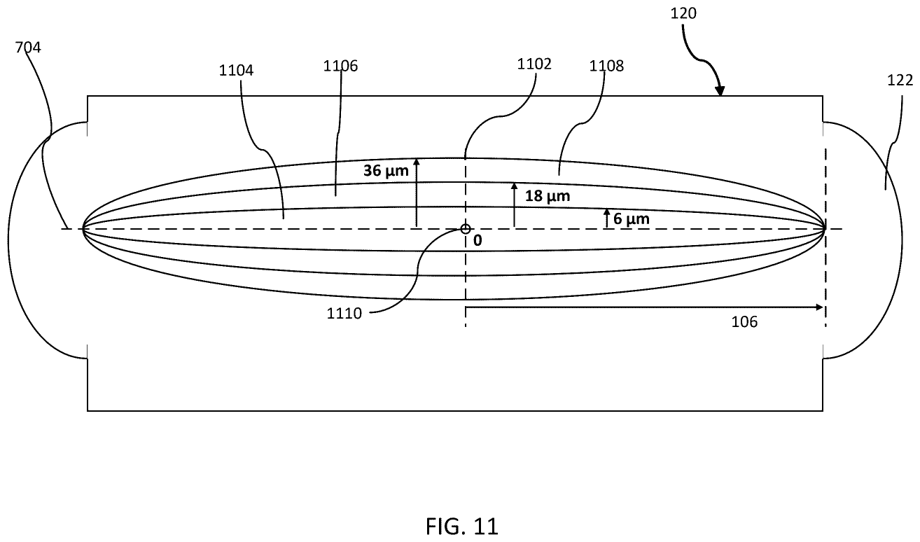

As described above, not all positioning of the photonic wirebond 110 relative to the microresonator 120 may produce coupling sufficient to generate solitons in the microresonator 120. Referring to FIG. 11, there is illustrated a cross-sectional view of a portion of the microresonator 120. FIG. 11 illustrates coupling volume zones within the microresonator 120 corresponding to zones of spatial positioning of the photonic wirebond 110 relative to the equator 704 of the protrusion 122 along a central axis 1102 of the microresonator 120 that can result in sufficient evanescent coupling such that solitons may be produced within the microresonator 120. In this example, three coupling volumes, or zones, are illustrated, namely a first coupling volume 1104, a second coupling volume 1106, and a third coupling volume 1108. The first coupling volume 1104 corresponds to a zone in which evanescent coupling from the photonic wirebond 110 has a 100% probability of producing resonances with solitons steps (provided the laser 604 is properly tuned to a resonance condition with the microresonator 120 and the optical beam in the optical waveguide 202 sufficient optical power, as described above). The second coupling volume 1106 corresponds to a zone in which evanescent coupling from the photonic wirebond 110 has a 50% probability of producing resonances with solitons steps, given the above-noted conditions. The third coupling volume 1108 corresponds to a zone in which evanescent coupling from the photonic wirebond 110 has less than 25% probability of producing resonances with solitons steps, even with the above-noted conditions.

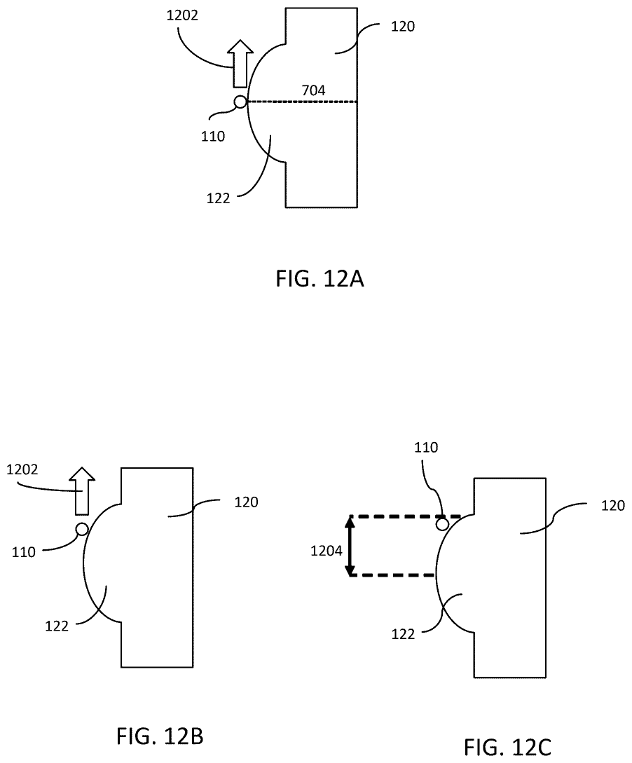

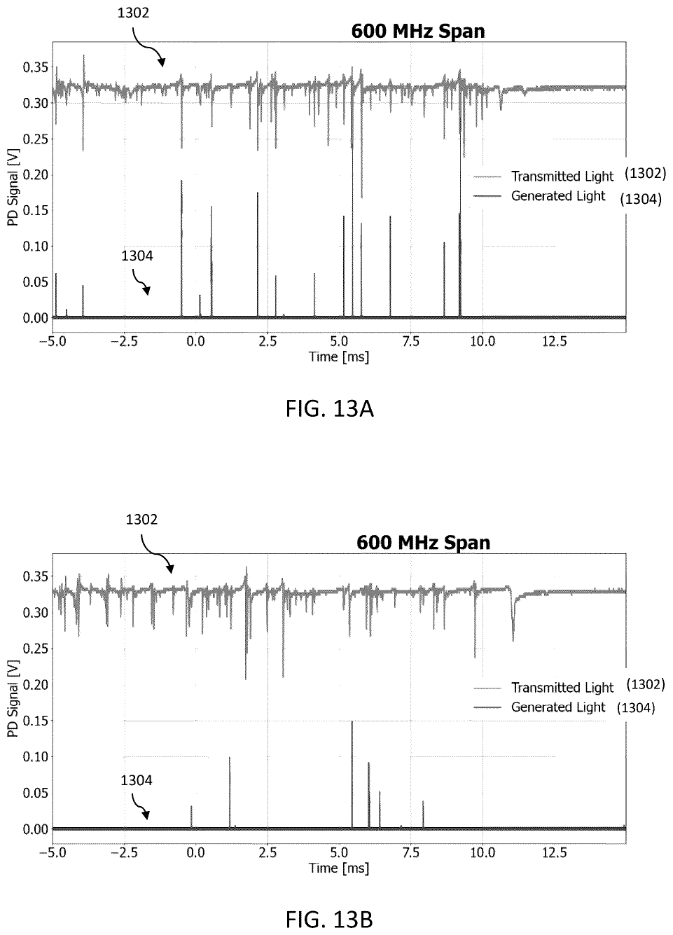

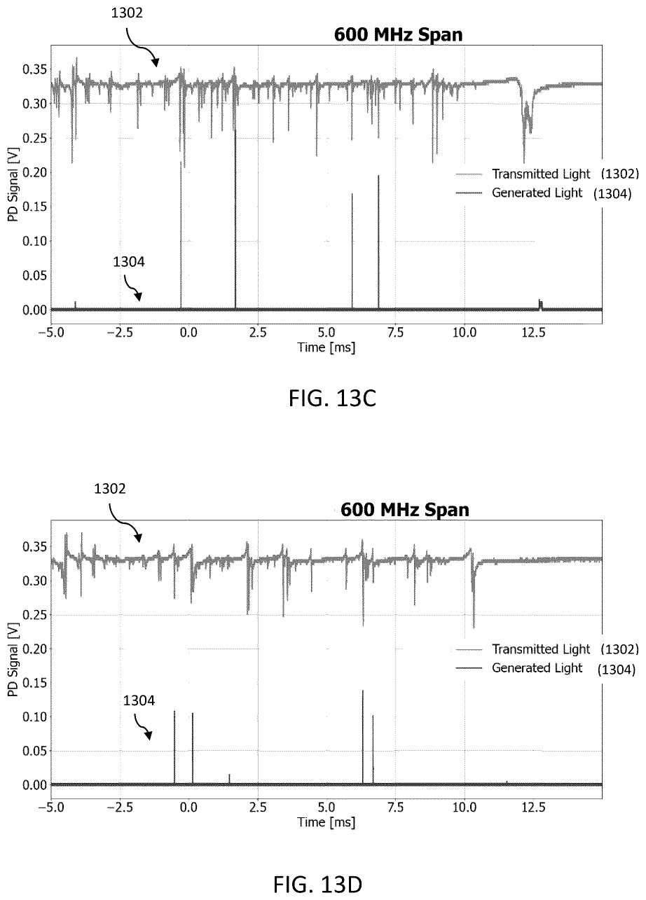

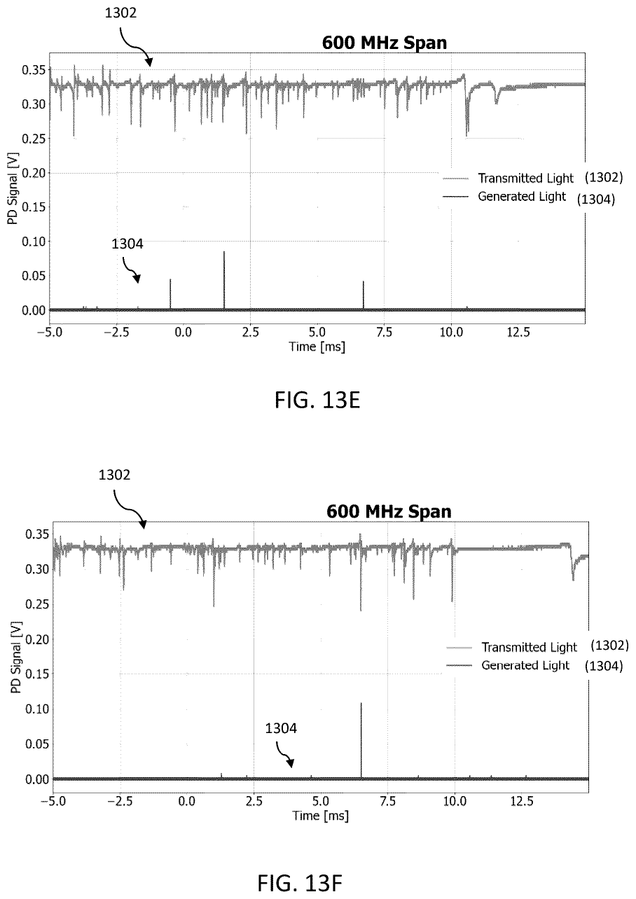

According to certain examples, the range of spatial positioning of the photonic wirebond 110 that corresponds to each of the coupling volumes 1104, 1106, 1108 can be determined by positioning the photonic wirebond 110 at various positions relative to the equator 704 of the protrusion 122 of the microresonator 120 and observing the modal profile/spectrum produced at the different positions. For example, Referring to FIGS. 11 and 12A-C, the photonic wirebond 110 can be positioned at an initial position (FIG. 12A) that corresponds to alignment with the equator 704 along the central axis 1102. This position corresponds to the center point 1110 shown in FIG. 11. According to certain examples, in the initial position, the photonic wirebond 110 is also positioned with a selected gap distance 702 between the end of the photonic wirebond 110 and the protrusion 122 that corresponds to the over-coupled condition and a desired extinction ratio. After desired measurements have been acquired, as described further below, the photonic wirebond can be moved in the dimension of the central axis 1102, as indicated by arrow 1202, to a new position (e.g., as shown in FIG. 12B) at which further measurements can be acquired. According to certain examples, the modal spectrum of the transmitted laser light from the microresonator 120 and the light generated in the microresonator (e.g., as discussed above with reference to FIG. 10) for each position of the photonic wirebond 110 can be observed using the system 900. Examples of these spectra, obtained using the system 900, are illustrated in FIGS. 13A-F.

For example, referring to FIG. 13A, there is illustrated an example of the modal profile obtained using the system 900 for the PIC 100 positioned such that the photonic wirebond 110 is aligned with the CenterPoint 1104. Trace 1302 represents the transmitted light that corresponds to light generated by the laser 604 and returned from the microresonator 120 via the photonic wirebond 110 and the return optical path, as described above with reference to FIG. 10. Trace 1304 presents the generated light that corresponds to additional light produced within the microresonator 120 and coupled into the return path via the photonic wirebond 110, as also described above with reference to FIG. 10. In the example of FIG. 13A, a 600 MHz frequency span is shown. A plurality of “spikes” in the transmitted light 1302 correspond to resonances in the microresonator 120. Spikes (or peaks) in the generated light 1304 correspond to occurrences of non-linear accumulations of optical power (e.g., as shown at 1006 in FIG. 10) within the microresonator 120, which may correspond to the generation of soliton steps, as described above. As may be seen by comparing traces 1302 and 1304 in FIG. 13A, not all resonances in the transmitted light 1302 have associated non-linearities. However, with the photonic wirebond 110 in the center point position (offset vertically, or along the central axis 1102, by 0 μm), it can be seen that there are more than 15 modes with non-linearities that may produce soliton steps.

Referring again to FIGS. 12A-C, as described above, the photonic wirebond 110 can be moved to different vertical offset positions relative to the equator 704 of the protrusion 122, as indicated by arrow 1202 in FIGS. 12A and 12B, until a maximum offset position is found at which very few or no non-linearities are observed in the generated light 1304. This maximum offset 1204 is illustrated in FIG. 12C and corresponds to the maximum vertical extent (or boundary) of the third coupling volume 1108 illustrated in FIG. 11. It will be appreciated, although not illustrated in FIGS. 12A-C, that as the photonic wirebond 110 is repositioned in the dimension of the central axis 1102, it may also be necessary to reposition the photonic wirebond in the dimension/plane of the equator 704 so as to maintain a desired coupling state and/or extinction ratio. For testing purposes, the movable stage 914 and/or the piezoelectric stage 916 can be used to reposition the PIC 100 and/or the microresonator 120, respectively, so as to achieve different offset positions of the photonic wirebond 110 relative to the microresonator 120. For systems in which the positions of the PIC 100 and/or the microresonator 120 are fixed, a robotic apparatus may be used to write the photonic wirebond 110 to different positions, as described further below.

FIGS. 13B-F are additional graphs showing examples of transmitted light (trace 1302) and generated light (trace 1304) produced for different offset positions of the photonic wirebond 110 along the dimension of the central axis 1102. Each of the graphs depicted in FIGS. 13B-F show a 600 MHz frequency span. As in FIG. 13A, in each of FIGS. 13B-F, spikes in the transmitted light 1302 represent resonance modes and spikes in the generated light 1304 represent modes with non-linearities. By comparing FIGS. 13A-F, it may be observed that the number of modes with non-linearities, and therefore the potential to produce soliton steps, decreases as the photonic wirebond 110 is moved along the dimension of the central axis 1102 away from the center point 1110.

FIG. 13B illustrates an example of a modal profile obtained with the photonic wirebond 110 positioned vertically offset (in the dimension of the central axis 1102) from the equator 704 by 6 μm. It can be seen that at least 7 modes with non-linearities exist. In some examples, this 6 μm offset corresponds to the boundary of the first coupling volume 1104, as shown in FIG. 11.

FIG. 13C illustrates an example of a modal profile obtained with the photonic wirebond 110 positioned vertically offset from the equator 704 by 13 μm. It can be seen that at least 6 modes with non-linearities exist.

FIG. 13D illustrates an example of a modal profile obtained with the photonic wirebond 110 positioned vertically offset from the equator 704 by 24 μm. It can be seen that at least 5 modes with non-linearities exist. In some examples, the boundary of the second coupling volume 1106 corresponds to a vertical offset position of the photonic wirebond 110 that is between the examples shown in FIG. 13C and FIG. 13D. In some examples, the boundary of the second coupling volume 1106 corresponds to the photonic wirebond positioned 18 μm offset from the equator 704, as shown in FIG. 11.

FIG. 13E illustrates an example of a modal profile obtained with the photonic wirebond 110 positioned vertically offset from the equator 704 by 29 μm. It can be seen that at least 3 modes with non-linearities exist.

FIG. 13F illustrates an example of a modal profile obtained with the photonic wirebond 110 positioned vertically offset from the equator 704 by 36 μm. It can be seen that at least 2 modes with non-linearities exist. In some examples, this offset position 36 μm from the equator 704 corresponds to the boundary of the third coupling volume 1108, as shown in FIG. 11. If the photonic wirebond 110 is positioned further vertically offset from the equator 704, it becomes increasingly unlikely that modes with non-linearities will be present, and therefore, increasingly unlikely that the coupling achieved would be sufficient to produce solitons in the microresonator 120. However, in other applications in which it is not an objective to produce solitons, the coupling achieved at this position and other positions of the photonic wirebond 110 farther from the equator 704 may be sufficient to achieve a useful result.

As can be seen with reference to FIGS. 13A-F, in these examples, while the transmitted light 1302 contains a large number of resonances, only a few of these resonances may exhibit the non-linearity needed to produce solitons. However, these results demonstrate that provided the photonic wirebond 110 is positioned such that the evanescent coupling is within the coupling volumes 1104, 1106, or 1108 illustrated in FIG. 11, there may be relatively high likelihood (given appropriate parameters of the laser 604) that one or more non-linear modes that can produce solitons will be present.

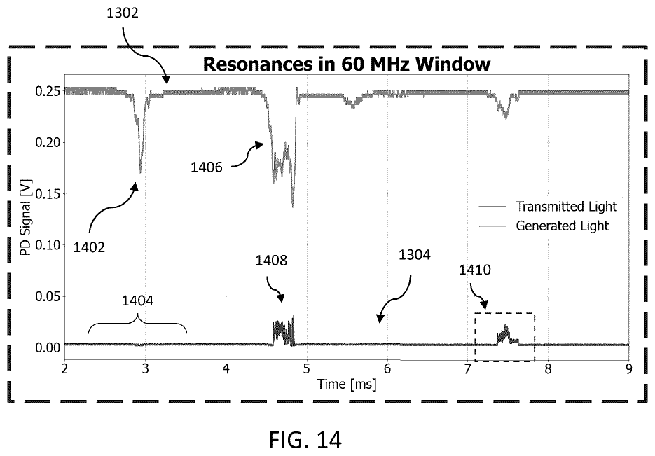

FIG. 14 illustrates an example of soliton formation. FIG. 14 is a graph showing an enlarged view of a portion of an example of a modal spectrum produced with the photonic wirebond 110 positioned offset 6 μm from the equator 704 of the protrusion 122 of the microresonator 120. In this example, the photonic wirebond 110 is further positioned in the plane of the equator 704 such that the evanescent coupling is in the over-coupled state. FIG. 14 illustrates a 60 MHz frequency window. It can be seen that a first resonance 1402 in the transmitted light 1302 does not produce (much) generated light (region 1404 in trace 1304); however, a second resonance 1406 in the transmitted light 1304 corresponds to a non-linearity 1408 in the generated light 1304. This non-linearity 1408 produces at least one soliton step 1410.

### Example Methodology

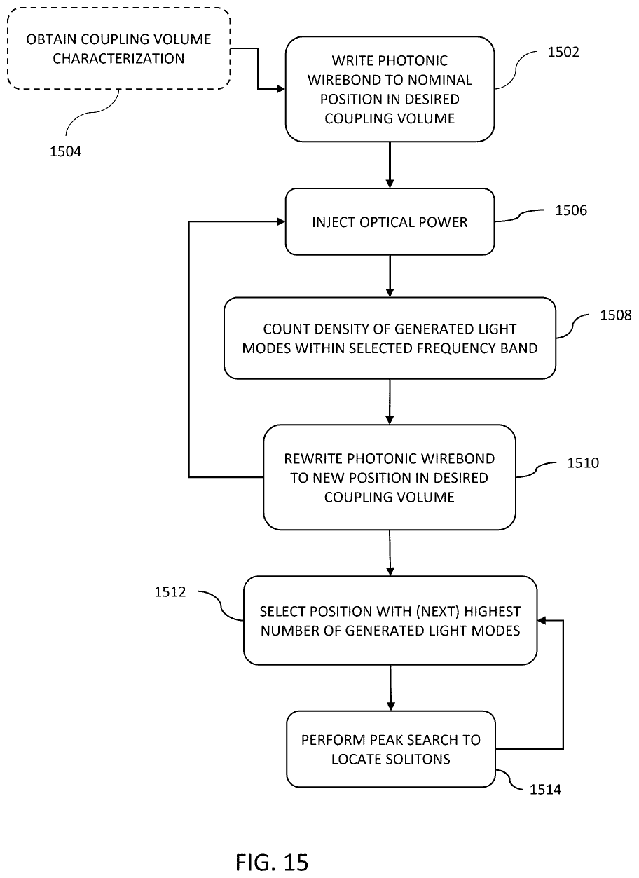

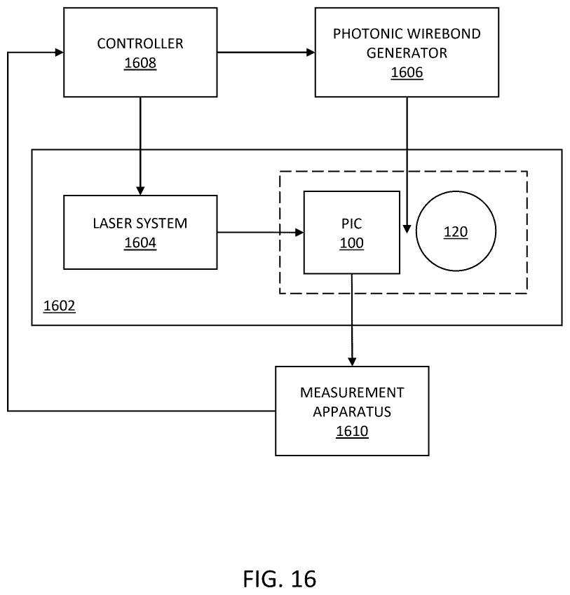

Referring to FIG. 15, there is illustrated a flow diagram of a process 1500 for automatically generating solitons in a whispering gallery mode microresonator, such as the microresonator 120, according to an example. The process 1500 may be automated and performed using a system 1600, such as that shown in FIG. 16, for example.

Referring to FIG. 16, the system 1600 may include a system under test 1602 that may include a laser system 1604, an example of the PIC 100, and an example of the microresonator 120. The laser system 1604 may include components as described above with reference to FIGS. 6 and 9, such as the laser 604, arbitrary waveform generator 602, isolator 606, fiber amplifier 902, and/or polarization controller 610, for example. The PIC 100 has the optical waveguide 202 formed thereon and may be arranged with respect to the microresonator 120 as shown in FIGS. 2A and 2B, for example. In some examples, positioning of the PIC 100 and the microresonator 120 may be fixed, and any adjustments to obtain desired coupling between the optical waveguide 202 and the microresonator 120 for soliton formation may be accomplished by varying the photonic wirebond 110. Accordingly, in some examples, the system 1600 includes a photonic wirebond generator 1606, which may include one or more robotic apparatuses for writing, and optionally removing, the photonic wirebond 110, under control of a controller 1608. The system 1600 may further include a measurement apparatus 1610 to detect the solitons, as described further below. In some examples, the measurement apparatus 1610 includes components such as those described above with reference to FIGS. 6 and 9, such as one or more photodetectors 612, 912, the oscilloscope 614, the splitter 906, notch filter 908, mixer 901, and/or OSA 904, for example.

Returning to FIG. 15, at operation 1502, a photonic wirebond 110 can be written, using the photonic wirebond generator 1606, to coupling facets of the optical waveguide 202 on the PIC 100, as described above with reference to FIG. 5, for example. In some examples, at operation 1502, the photonic wirebond 110 can be placed at a nominal coupling position within the range of offsets from the center point 1110 corresponding to the first coupling volume 1104, so as to maximize the probability of locating a resonance that produces a soliton step. In addition, the photonic wirebond 110 may be written such that the gap distance 702 corresponds to the over-coupled coupling state and a selected extinction ratio is achieved, as described above.

To achieve a desired nominal positioning of the photonic wirebond 110 at operation 1502, in some examples, the process 1500 may include acquiring coupling volume characterization information at operation 1504. As described above, a system such as the systems 600 and/or 900 can be used to characterize the dependence of the evanescent coupling (e.g., the coupling state and/or the extinction ratio at one or more resonant frequencies) between the photonic wirebond 110 and the microresonator 120 on the spatial positioning of the photonic wirebond 110 relative to the microresonator 120. Once known, this coupling dependence information can be used to control the photonic wirebond generator 1606 to write the photonic wirebond 110 to the PIC 100 in such a manner that a desired coupling is achieved. In some examples, the spatial dependence of the coupling can be characterized for a generalized system-under-test 1602 given a particular set of parameters specifying characteristics of the microresonator 120, the photonic wirebond 110, and the laser system 1604. For example, this set of parameters may specify a particular crystalline material (e.g., MgF2) and diameter of the microresonator 120, a structure (e.g., geometric shape) and material of the photonic wirebond 110 (e.g., as discussed above with reference to FIGS. 3 and 4), and certain parameters of the light produced by the laser 604 (e.g., frequency span, optical power). Once the spatial dependence of the coupling has been characterized (e.g., as described above with reference to FIGS. 6-14) for particular type of system-under-test 1602 with a given set of a parameters, this spatial dependence may be the same, or similar, for other systems-under-test 1602 with the same set of parameters. Accordingly, in some examples, the characterization need not be performed for each instance of the process 1500. Rather, in some examples, operation 1504 may include obtaining a data set specifying the coupling volume characterization based on spatial positioning of the photonic wirebond in three dimensions. This data set may have been produced based on a prior characterization process performed for the particular system-under-test 1602 being used during a given instance of the process 1500 or a similar system-under-test. In some examples, the data set may be programmed into the photonic wirebond generator 1606 or the controller 1608 and can be used to write the photonic wirebond 110 in operation 1502. Accordingly, operation 1504 may include reading information from one or more computer readable media that are part of, or can be accessed by, the controller 1608 and/or the photonic wirebond generator 1606.

In some examples, the photonic wirebond generator 1606 can be precisely controlled such that the photonic wirebond 110 can be written at operation 1502 with very precise dimensions and spatial positioning relative to the microresonator 120. As described above, in some examples, the photonic wirebond 110 is made of a photoresist material, such as SU-8, for example, and can be written using 3D printing or laser etching techniques. For example, to write the photonic wirebond 110, the photonic wirebond generator 1606 can be equipped with a 3D printer and programmed with dimensions and a desired spatial positioning of the photonic wirebond 110, such that the photonic wirebond 110 can be printed from a selected material using 3D printing techniques. Further, in some examples, the photonic wirebond 110 can be written, based on known dimensions of the microresonator 120 and a known distance between the edge of the PIC 100 (where the photonic wirebond 110 is coupled to the optical waveguide 202) and the microresonator 120, such that droop due to gravity (as described above with reference to FIG. 2B) causes the loop portion 304 to contact the protrusion 122 of the microresonator 120 and the photonic wirebond is positioned within the region corresponding to the first coupling volume 1104. In some examples, positioning the photonic wirebond 110 such that it droops onto the protrusion 122 of the microresonator 120 has advantages in terms of coupling performance and robustness. For example, the contact point between the photonic wirebond 110 and protrusion 122 of the microresonator 120 may provide a mechanically robust interface because the photonic wirebond 110 does not readily lose contact with the microresonator 120 under vibration or thermal expansion. In some examples, chemical attraction, such as can der Waals force, between the photonic wirebond and the protrusion 122, acts to hold the photonic wirebond 110 in contact with the microresonator 120. Furthermore, any temperature variation causing thermorefractive changes in the MgF2 material can be compensated for using thermal regulation. In addition, as demonstrated in the results shown in FIG. 8B, positioning the photonic wirebond 110 in contact with the microresonator 120 may produce the over-coupled coupling state, which may be conducive to soliton formation.

Still referring to FIG. 15, at operation 1506, the laser system 1604 can be controlled (e.g., by the controller 1608) to inject optical power into the optical waveguide 202. At least some of this optical power is then coupled into the microresonator 120 via the photonic wirebond 110, as described above. At operation 1506, the optical power can be controlled to reach the level needed for soliton generation in the microresonator 120.

At operation 1508, the density of generated light modes in the microresonator 120 can be counted within a specified frequency range. For example, as described above with reference to FIGS. 13A-F, spikes in the trace 1304 represent generated light modes with non-linearities that may produce soliton steps. Accordingly, the measurement apparatus 1610, and optionally the controller 1608, may be used to count the number of generated light modes (“spikes”) for the current position of the photonic wirebond 110. This count information may be stored in a computer readable storage medium that can be accessed by the measurement apparatus 1610 and/or the controller 1608, together with the corresponding positional information of the photonic wirebond 110.

At operation 1510, the existing photonic wirebond can be removed, using the photonic wirebond generator 1606, and rewritten to a new position within the ranges corresponding to the desired coupling volume. As described above, the photonic wirebond 110 can be made of a photoresist material, and therefore may be easily removed by the photonic wirebond generator 1606. The photonic wirebond generator 1606 may then write a new photonic wirebond 110 with dimensions, droop, and/or positioning corresponding to a new coupling position within the desired coupling volume (e.g., the first coupling volume 1104 of FIG. 11).

Operations 1506 and 1508 may then be repeated for the new position of the photonic wirebond 110. Operations 1510, 1506, and 1508 may repeated any number of times to reposition the photonic wirebond 110 over the ranges corresponding to the first coupling volume 1104, for example. In some examples, the controller 1608 can be programmed with a particular number, or range, of positions for the photonic wirebond, and therefore number of times that operations 1510, 1506, and 1508 are to be repeated.

At operation 1512, the position of the photonic wirebond 110 corresponding to the highest number of generated light modes may be selected. The photonic wirebond generator 1606 may be controlled to write the photonic wirebond 110 to the selected position.

At operation 1514, a peak search may be performed to locate one or more soliton steps. If no solitons are located, the photonic wirebond 110 can be removed and rewritten to the location corresponding to the next highest number of generator light modes (recorded at operation 1508). In some examples, operation 1514 may be performed as part of operation 1508, or following operation 1508 prior to removing and rewriting the photonic wirebond 110 at operation 1510. This may reduce the amount of time and/or rewriting steps needed to select a final position for the photonic wirebond 110 that produces one or more soliton steps in the microresonator 120. Further, in some examples, if at least one soliton step is observed with the photonic wirebond 110 in the nominal position (at operation 1502), the process 1500 may exclude operation 1510 and operation 1512 may include the selecting the nominal position of the photonic wirebond 110.

Thus, the system 1600 can be used to automatically perform the process 1500 to locate a precise configuration and position of the photonic wirebond 110 that has coupling characteristics suitable for soliton generation. The photonic wirebond generator 1606 can be controlled (e.g., by the controller 1608) to passively align photonic wirebonds to discrete photonic elements, such as the crystalline microresonator 120, during the writing process without requiring active/manual intervention by a human expert, which may greatly increase the manufacturability of the soliton generation process.

### Example Computing Platform

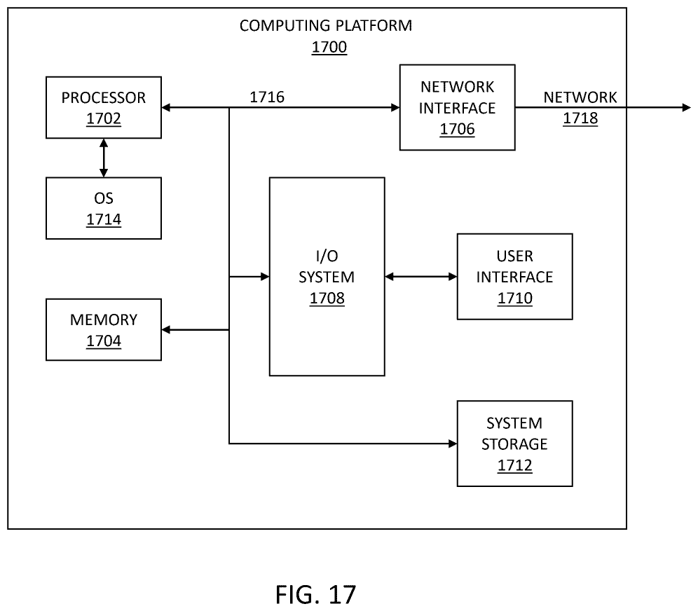

FIG. 17 illustrates an example computing platform 1700 that can be used to implement some components and/or functionality of the system 1600 described herein, such as the controller 1608 and/or aspects of the photonic wirebond generator 1606, laser system 1604, and/or measurement apparatus 1610. In some embodiments, the computing platform 1700 may host, or otherwise be incorporated into a personal computer, workstation, server system, laptop computer, ultra-laptop computer, tablet, touchpad, portable computer, handheld computer, palmtop computer, personal digital assistant (PDA), cellular telephone, combination cellular telephone and PDA, smart device (for example, smartphone or smart tablet), mobile internet device (MID), messaging device, data communication device, imaging device, wearable device, embedded system, and so forth. Any combination of different devices may be used in certain embodiments. In some embodiments, the computing platform 1700 represents one system in a network of systems coupled together via controlled area network (CAN) bus or other network bus.

In some examples, the computing platform 1700 may comprise any combination of a processor 1702, a memory 1704, a network interface 1706, an input/output (I/O) system 1708, a user interface 1710, and a storage system 1712. In some embodiments, the controller 1608 is implemented as part of the processor 1702. As shown in FIG. 17, a bus and/or interconnect 1716 is also provided to allow for communication between the various components listed above and/or other components not shown. The computing platform 1700 can be coupled to a network 1718 through the network interface 1706 to allow for communications with other computing devices, platforms, or resources. Other componentry and functionality not reflected in the block diagram of FIG. 17 will be apparent in light of this disclosure, and it will be appreciated that other embodiments are not limited to any particular hardware configuration.

The processor 1702 can be any suitable processor and may include one or more coprocessors or controllers to assist in control and processing operations associated with the computing platform 1700. In some embodiments, the processor 1702 may be implemented as any number of processor cores. The processor (or processor cores) may be any type of processor, such as, for example, a micro-processor, an embedded processor, a digital signal processor (DSP), a graphics processor (GPU), a network processor, a field programmable gate array or other device configured to execute code. The processors may be multithreaded cores in that they may include more than one hardware thread context (or “logical processor”) per core.

The memory 1704 can be implemented using any suitable type of digital storage including, for example, flash memory and/or random access memory (RAM). In some embodiments, the memory 1704 may include various layers of memory hierarchy and/or memory caches as are known to those of skill in the art. The memory 1704 may be implemented as a volatile memory device such as, but not limited to, a RAM, dynamic RAM (DRAM), or static RAM (SRAM) device. The storage system 1712 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device. In some embodiments, the storage system 1712 may comprise technology to increase the storage performance enhanced protection for valuable digital media when multiple hard drives are included. The storage system 1712 and/or the memory 1704 may store data regarding coupling dependence information for various systems-under-test 1602 and/or types of systems-under-test, as described above.

The processor 1702 may be configured to execute an Operating System (OS) 1714 which may comprise any suitable operating system, such as Google Android (Google Inc., Mountain View, CA), Microsoft Windows (Microsoft Corp., Redmond, WA), Apple OS X (Apple Inc., Cupertino, CA), Linux, or a real-time operating system (RTOS). As will be appreciated in light of this disclosure, the techniques provided herein can be implemented without regard to the particular operating system provided in conjunction with the computing platform 1700, and therefore may also be implemented using any suitable existing or subsequently-developed platform.

The network interface 1706 can be any appropriate network chip or chipset which allows for wired and/or wireless connection between other components of the computing platform 1700 and/or the network 1718, thereby enabling the computing platform 1700 to communicate with other local and/or remote computing systems, servers, cloud-based servers, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution), Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

The I/O system 1708 may be configured to interface between various I/O devices and other components of the computing platform 1700. I/O devices may include, but not be limited to, a user interface 1710. The user interface 1710 may include devices (not shown) such as a display element, touchpad, keyboard, mouse, and/or speaker, to allow a user to interact with the computing platform 1700.

It will be appreciated that in some embodiments, the various components of the computing platform 1700 may be combined or integrated in a system-on-a-chip (SoC) architecture. In some embodiments, the components may be hardware components, firmware components, software components or any suitable combination of hardware, firmware or software.

In various embodiments, the computing platform 1700 may be implemented as a wireless system, a wired system, or a combination of both. When implemented as a wireless system, the computing platform 1700 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, the computing platform 1700 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical quantities within the registers, memory units, or other such information storage transmission or displays of the computer system. The embodiments are not limited in this context.

The terms “circuit” or “circuitry,” as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, and/or firmware, configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, and/or smart phones. Other embodiments may be implemented as software executed by a programmable control device. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, GPUs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

### FURTHER EXAMPLE EMBODIMENTS

The following examples pertain to further embodiments, from which numerous permutations and configurations will be apparent.

Example 1 provides a method comprising writing a photonic wirebond to at least one optical waveguide to position the photonic wirebond at a first coupling position relative to a crystalline microresonator, injecting optical power into the at least one optical waveguide, determining a number of generated light modes within the crystalline microresonator, and performing a peak search to locate at least one soliton step corresponding to at least one of the generated light modes within the crystalline microresonator.

Example 2 includes the method of Example 1, comprising rewriting the photonic wirebond at one or more second coupling positions relative to the crystalline microresonator, wherein determining the number of generated light modes includes determining a number of generated light modes within the crystalline microresonator corresponding to each of the first coupling position and the one or more second coupling positions.

Example 3 includes the method of Example 2, comprising selecting a coupling position of the photonic wirebond from among the first coupling position and the one or more second coupling positions in which the number of generated light modes is highest, and wherein performing the peak search includes performing the peak search with the photonic wirebond positioned at the selected coupling position.

Example 4 includes the method of one of Examples 2 or 3, wherein rewriting the photonic wirebond comprises removing the photonic wirebond from a current coupling position and sequentially writing a new photonic wirebond at the one or more second coupling positions.

Example 5 includes the method of any one of Examples 1-4, comprising acquiring coupling dependence information characterizing a dependence of evanescent coupling between the photonic wirebond and the crystalline microresonator on spatial positioning of the photonic wirebond relative to the crystalline microresonator, and wherein writing the photonic wirebond comprising determining the first coupling position based on the coupling dependence information.

Example 6 includes the method of any one of Examples 1-5, wherein the writing the photonic wirebond comprises performing a three-dimensional printing process.

Example 7 includes the method of any one of Examples 1-6, wherein writing the photonic wirebond comprises forming the photonic wirebond of a negative-tone photoresist material.

Example 8 includes the method of any one of Examples 1-7, wherein writing the photonic wirebond comprises forming the photonic wirebond having a loopback structure including first and second end regions coupled to the at least one optical waveguide and a loopback portion extending between the first and second end regions.

Example 9 includes the method of any one of Examples 1-8, writing the photonic wirebond comprises forming the loopback portion with an elliptical profile.

Example 10 includes the method of Example 9, wherein writing the photonic wirebond comprises forming the first and second end regions as tapered regions each having a circular profile, and wherein a diameter of the circular profile matches a minor diameter of the elliptical profile of the loopback portion.

Example 11 includes the method of any one of Examples 1-10, wherein the crystalline microresonator includes an annular protrusion, and wherein writing the photonic wirebond at the first coupling position comprises writing the photonic wirebond to contact the annular protrusion of the crystalline microresonator.

Example 12 includes the method of Example 11, wherein writing the photonic wirebond includes adjusting a droop of the photonic wirebond such that the photonic wirebond contacts the annular protrusion at a position to achieve a selected extinction ratio.

Example 13 provides a system comprising a photonic integrated circuit having at least one optical waveguide formed thereon, a crystalline microresonator spaced apart from the photonic integrated circuit, a laser system coupled to the at least one optical waveguide, and a photonic wirebond generator. The system may further comprise a controller configured to control the photonic wirebond generator to write a photonic wirebond to at least one optical waveguide to position the photonic wirebond at a first coupling position relative to a crystalline microresonator, control the laser system to inject optical power into the at least one optical waveguide, determine a number of generated light modes within the crystalline microresonator, and perform a peak search to locate at least one soliton step corresponding to at least one of the generated light modes within the crystalline microresonator.

Example 14 includes the system of Example 13, wherein the controller is configured to control the photonic wirebond generator to rewrite the photonic wirebond at one or more second coupling positions relative to the crystalline microresonator, and to determine the number of generated light modes within the crystalline microresonator corresponding to each of the first coupling position and the one or more second coupling positions.

Example 15 includes the system of Example 14, wherein the controller is configured to identify a coupling position of the photonic wirebond from among the first coupling position and the one or more second coupling positions in which the number of generated light modes is highest, control the photonic wirebond generator to write the photonic wirebond at the identified coupling position, and perform the peak search with the photonic wirebond positioned at the identified coupling position.

Example 16 includes the system of any one of Examples 13-15, wherein the controller is configured determine the first coupling position based on coupling dependence information that characterizes a dependence of evanescent coupling between the photonic wirebond and the crystalline microresonator on spatial positioning of the photonic wirebond relative to the crystalline microresonator.

Example 17 includes the system of Example 16, comprising one or more computer readable storage media coupled to the controller and storing the coupling dependence information.

Example 18 includes the system of any one of Examples 13-17, wherein the crystalline microresonator is made of magnesium fluoride and wherein the photonic wirebond is made of a negative-tone photoresist material.

Example 19 includes the system of any one of Examples 13-18, wherein the at least one optical waveguide includes a first optical waveguide and a second optical waveguide, wherein the photonic wirebond is formed as a loop extending from a first facet of the first optical waveguide to a second facet of the second optical waveguide, and wherein the photonic wirebond includes a first end region attached to the first facet of the first optical waveguide, a second end region attached to the second facet of the second optical waveguide, and a loop portion extending between the first and second end regions, the first and second end regions having a circular profile, and the loop portion having an elliptical profile.

Example 20 includes the system of Example 19, wherein the first and second end regions are tapered, having a first diameter at the first and second facets, respectively, and a second diameter at respective junctions with the loop portion, wherein the second diameter is smaller than the first diameter, and wherein the second diameter matches a minor diameter of the elliptical profile of the loop portion.

Example 21 provides a computer program product comprising one or more non-transitory machine-readable mediums having instructions encoded thereon that when executed by at least one processor cause a method for generating solitons in a microresonator to be carried out. In some examples, the method comprises writing a photonic wirebond to at least one optical waveguide to position the photonic wirebond at a first coupling position relative to the microresonator, injecting optical power into the at least one optical waveguide, determining a number of generated light modes within the microresonator, and performing a peak search to locate at least one soliton step corresponding to at least one of the generated light modes within the microresonator.

Example 22 includes the computer program product of Example 21 wherein the method comprises rewriting the photonic wirebond at one or more second coupling positions relative to the crystalline microresonator, wherein determining the number of generated light modes includes determining the number of generated light modes within the crystalline microresonator corresponding to each of the first coupling position and the one or more second coupling positions.

Example 23 includes the computer program product of Example 22, wherein the method comprises selecting a coupling position of the photonic wirebond from among the first coupling position and the one or more second coupling positions in which the number of generated light modes is highest, and wherein performing the peak search includes performing the peak search with the photonic wirebond positioned at the selected coupling position.

Example 24 includes the computer program product of one of Examples 22 or 23, wherein rewriting the photonic wirebond comprises removing the photonic wirebond from a current coupling position and sequentially writing a new photonic wirebond at the one or more second coupling positions.

Example 25 includes the computer program product of any one of Examples 21-24, wherein the method comprises acquiring coupling dependence information characterizing a dependence of evanescent coupling between the photonic wirebond and the crystalline microresonator on spatial positioning of the photonic wirebond relative to the crystalline microresonator, and wherein writing the photonic wirebond comprising determining the first coupling position based on the coupling dependence information.

Example 26 includes the computer program product of any one of Examples 21-25, wherein writing the photonic wirebond comprises forming the photonic wirebond having a loopback structure including first and second end regions coupled to the at least one optical waveguide and a loopback portion extending between the first and second end regions.

Example 27 includes the computer program product of any one of Examples 21-26, wherein writing the photonic wirebond comprises forming the loopback portion with an elliptical profile.

Example 28 includes the computer program product of Example 27, wherein writing the photonic wirebond comprises forming the first and second end regions as tapered regions each having a circular profile, and wherein a diameter of the circular profile matches a minor diameter of the elliptical profile of the loopback portion.

Example 29 includes the computer program product of any one of Examples 21-28, wherein the crystalline microresonator includes an annular protrusion, and wherein writing the photonic wirebond at the first coupling position comprises writing the photonic wirebond to contact the annular protrusion of the crystalline microresonator.

Example 30 provides a method of producing a soliton in a crystalline microresonator, the method comprising (i) writing a photonic wirebond to at least one optical waveguide to position the photonic wirebond at a first coupling position relative to a crystalline microresonator, (ii) injecting optical power at a first level into the at least one optical waveguide, (iii) adjusting the first coupling position to obtain a selected extinction ratio, (iv) increasing the optical power to a second level, and (v) determining a density of generated light modes within the crystalline microresonator over a selected frequency range. The method further includes (vi) removing the photonic wirebond, and repeating acts (i) to (v) for a plurality of different coupling positions of the photonic wirebond. The method further includes (vii) selecting, from among the first coupling position and the plurality of coupling positions, a selected coupling position having a highest density of the generated light modes, and (viii) performing a peak search to locate at least one soliton step corresponding to at least one of the generated light modes within the crystalline microresonator. If no soliton step is located in act (viii), the method may further include repeating acts (vi) and (i) to (iv), selecting a second selecting coupling position having a second-highest density of the generated light modes, and repeating act (viii) for the second selected coupling position.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A method comprising:
writing a photonic wirebond to at least one optical waveguide to position the photonic wirebond at a first coupling position relative to a crystalline microresonator;
injecting optical power into the at least one optical waveguide;
determining a number of generated light modes within the crystalline microresonator; and
performing a peak search to locate at least one soliton step corresponding to at least one of the generated light modes within the crystalline microresonator.

2. The method of claim 1, comprising:
rewriting the photonic wirebond at one or more second coupling positions relative to the crystalline microresonator;
wherein determining the number of generated light modes includes determining the number of generated light modes within the crystalline microresonator corresponding to each of the first coupling position and the one or more second coupling positions.

3. The method of claim 2, comprising:
selecting a coupling position of the photonic wirebond from among the first coupling position and the one or more second coupling positions in which the number of generated light modes is highest;
wherein performing the peak search includes performing the peak search with the photonic wirebond positioned at the selected coupling position.

4. The method of claim 2, wherein rewriting the photonic wirebond comprises removing the photonic wirebond from a current coupling position and sequentially writing a new photonic wirebond at the one or more second coupling positions.

5. The method of claim 1, comprising:
acquiring coupling dependence information characterizing a dependence of evanescent coupling between the photonic wirebond and the crystalline microresonator on spatial positioning of the photonic wirebond relative to the crystalline microresonator; and
wherein writing the photonic wirebond comprising determining the first coupling position based on the coupling dependence information.

6. The method of claim 1, wherein the writing the photonic wirebond comprises performing a three-dimensional printing process.

7. The method of claim 1, wherein writing the photonic wirebond comprises forming the photonic wirebond of a negative-tone photoresist material.

8. The method of claim 1, wherein writing the photonic wirebond comprises forming the photonic wirebond having a loopback structure including first and second end regions coupled to the at least one optical waveguide and a loopback portion extending between the first and second end regions.

9. The method of claim 8, wherein writing the photonic wirebond comprises forming the loopback portion with an elliptical profile.

10. The method of claim 9, wherein writing the photonic wirebond comprises forming the first and second end regions as tapered regions each having a circular profile; and
wherein a diameter of the circular profile matches a minor diameter of the elliptical profile of the loopback portion.

11. The method of claim 1, wherein the crystalline microresonator includes an annular protrusion, and wherein writing the photonic wirebond at the first coupling position comprises writing the photonic wirebond to contact the annular protrusion of the crystalline microresonator.

12. A system comprising:
a photonic integrated circuit having at least one optical waveguide formed thereon;
a crystalline microresonator spaced apart from the photonic integrated circuit;
a laser system coupled to the at least one optical waveguide;
a photonic wirebond generator; and
a controller configured to
control the photonic wirebond generator to write a photonic wirebond to at least one optical waveguide to position the photonic wirebond at a first coupling position relative to a crystalline microresonator,
control the laser system to inject optical power into the at least one optical waveguide,
determine a number of generated light modes within the crystalline microresonator, and
perform a peak search to locate at least one soliton step corresponding to at least one of the generated light modes within the crystalline microresonator.

13. The system of claim 12, wherein the controller is configured to:
control the photonic wirebond generator to rewrite the photonic wirebond at one or more second coupling positions relative to the crystalline microresonator; and
to determine the number of generated light modes within the crystalline microresonator corresponding to each of the first coupling position and the one or more second coupling positions.

14. The system of claim 13, wherein the controller is configured to
identify a coupling position of the photonic wirebond from among the first coupling position and the one or more second coupling positions in which the number of generated light modes is highest;
control the photonic wirebond generator to write the photonic wirebond at the identified coupling position; and
perform the peak search with the photonic wirebond positioned at the identified coupling position.

15. The system of claim 12, wherein the controller is configured determine the first coupling position based on coupling dependence information that characterizes a dependence of evanescent coupling between the photonic wirebond and the crystalline microresonator on spatial positioning of the photonic wirebond relative to the crystalline microresonator.

16. The system of claim 15, comprising one or more computer readable storage media coupled to the controller and storing the coupling dependence information.

17. The system of claim 12, wherein the crystalline microresonator is made of magnesium fluoride and wherein the photonic wirebond is made of a negative-tone photoresist material.

18. The system of claim 12, wherein the at least one optical waveguide includes a first optical waveguide and a second optical waveguide;
wherein the photonic wirebond is formed as a loop extending from a first facet of the first optical waveguide to a second facet of the second optical waveguide; and
wherein the photonic wirebond includes a first end region attached to the first facet of the first optical waveguide, a second end region attached to the second facet of the second optical waveguide, and a loop portion extending between the first and second end regions, the first and second end regions having a circular profile, and the loop portion having an elliptical profile.

19. The system of claim 18, wherein the first and second end regions are tapered, having a first diameter at the first and second facets, respectively, and a second diameter at respective junctions with the loop portion, wherein the second diameter is smaller than the first diameter, and wherein the second diameter matches a minor diameter of the elliptical profile of the loop portion.

20. A computer program product comprising one or more non-transitory machine-readable mediums having instructions encoded thereon that when executed by at least one processor cause a method for generating solitons in a microresonator to be carried out, the method comprising:
writing a photonic wirebond to at least one optical waveguide to position the photonic wirebond at a first coupling position relative to the microresonator;
injecting optical power into the at least one optical waveguide;
determining a number of generated light modes within the microresonator; and
performing a peak search to locate at least one soliton step corresponding to at least one of the generated light modes within the microresonator.
